(19) United States
(12) Patent Application Publication
(10) Pub. No.: US 2016/0192251 A1
(43) Pub. Date: Jun. 30, 2016

(54) SCHEME FOR SCANNING RADIO ACCESS TECHNOLOGY (RAT) IN A CELLULAR COMMUNICATION SYSTEM

(71) Applicant: Samsung Electronics Co., Ltd., Gyeonggi-do (KR)

(72) Inventors: Praveen CHEBOLU, Gyeonggi-do (KR); Pavan Kumar DEVARAYANIGARI, Bangalore (IN); Krishna Sumanth VEMURI, Bangalore (IN); Jai-Dong KIM, Gyeonggi-do (KR); Hyeun-Mok JUNG, Gyeonggi-do (KR)

(73) Assignee: Samsung Electronics Co., Ltd.

(21) Appl. No.: 14/733,440

(22) Filed: Jun. 8, 2015

(30) Foreign Application Priority Data
Dec. 24, 2014 (KR) 10-2014-0188568

(51) Int. Cl. H04W 36/00; H04W 76/02; H04W 74/08

(52) U.S. Cl. CPC H04W 36/0088; H04W 74/0833; H04W 76/028; H04W 84/042

(57) ABSTRACT

An apparatus and method for scanning Radio Access Technology (RAT) of a User Equipment (UE) registered in a first cell in a cellular communication network is provided. The method includes performing a Non-Access Stratum (NAS) procedure for establishing a call, disabling, if the NAS procedure fails, capability of the UE to connect to the first cell, checking information relating to neighboring cells in the network, and selecting at least one RAT included in the information relating to the neighboring cells, and scanning a second cell operating in the at least one RAT based on the information relating to the neighboring cells.

### PRIORITY

This application claims priority under 35 U.S.C. §119(a) to Korean Patent Application Serial No. 10-2014-0188568 which was filed in the Korean Intellectual Property Office on Dec. 24, 2014, the entire disclosure of which is incorporated herein by reference.

### BACKGROUND

1. Field of the Disclosure

The present disclosure relates generally to a scheme for scanning Radio Access Technology (RAT) in a cellular communication system, and more particularly, to a scheme for scanning RAT in a cellular communication system, which is capable of reducing a delay time and battery consumption due to scan failure.

2. Description of the Related Art

With a recent trends in which User Equipment (UE) supports RAT, the processing complexity of UE in handling RAT is increasing. There are numerous problems that a UE can experience in order to support a plurality of RAT. Examples of various problems that a UE can experience in order to support various RAT can include:
a) according to Section 4.3.1 of the 3rd Generation Partnership Project (3GPP) Technical Specification (TS) 24.301, if a UE that has registered in a Long Term Evolution (LTE) network initializes an emergency call (EMC), a circuit switched fallback (CSFB) procedure is initialized. At this time, if the CSFB procedure of the UE fails, the UE selects second-generation (2G) RAT, such as Global System for Mobile Communications (GSM) or third-generation (3G) RAT, such as Universal Mobile Telecommunications System (UMTS).
b) according to Section 4.3.2.2 and Section 4.5 of the 3GPP TS 24.301, the operation setting (for example, PS mode 1 or PS mode 2) of a UE changes from data centric to voice centric and Instant Messaging Service (IMS) “IMS voice not available”, the UE disables Evolved Universal Mobile Telecommunication Systems (UMTS) Terrestrial Radio Access (EUTRA) capability which is a radio interface for LTE. Then, the UE selects RAT to connect to a 2G network such as GSM EDGE Radio Access Network (GERAN) or a 3G network such as UMTS TRA network (UTRAN).
c) according to Section 4.3.2.2 and Section 4.5 of the 3GPP TS 24.301, if the operation setting (for example, CS/PS mode 1 or CS/PS mode 2) of a UE changes from data centric to voice centric, “Circuit Switched (CS) fallback not available”, and “IMS voice not available”, the UE disables the EUTRA capability. Then, the UE selects RAT such as GERAN or UTRAN.
d) according to Section 5.5.1.3.4.2 of the 3GPP TS 24.301, if an attach accept message is received together with “Short Message Service (SMS) Only” or “ CS fallback not preferred” during a combined attach procedure in LTE, UE operating in CS/PS mode 1 selects GERAN or UTRAN. Herein, the combined attach procedure is combined attach of CS and Packet Switched (PS).
e) according to Section 5.5.1.3.4.3 of the 3GPP TS 24.301, if an attach accept message for “Evolved Packet System (EPS) service only” is received together with information indicating “network failure” (clause 417) during the combined attach procedure in LTE, the UE operating in CS/PS mode 1 selects GERAN or UTRAN.
f) according to Section 5.5.1.3.4.3 of the 3GPP TS 24.301, if an attach accept message indicating “CS domain not available” (clause #18) is received during the combined attach procedure in LTE, the UE operating in CS/PS mode 1 selects GERAN or UTRAN.
g) according to Section 5.5.1.3.4.3 of the 3GPP TS 24.301, if combined attach is not accepted by the network due to “EPS service not available in Public Land Mobile Network (PLMN)” (clause #14), the UE operating in CS/PS mode 1 selects GERAN or UTRAN.
h) if any situation mentioned in (d) to (g) occurs during a Tracking Area Update (TAU) or Service Request (SR) procedure, the UE selects GERAN or UTRAN.
i) As another example, at any abnormal situation that may occur during the CSFB procedure, UE should select RAT such as GERAN or UTRAN.

In the above cases, the UE selects RAT such as GERAN or UTRAN without applying any criteria to scan the RAT.

For example, the UE may scan RAT which has weak signal intensity or RAT which is not supported by the UE. As another example, the UE may scan 3G Frequency Division Duplex (FDD) RAT when 3G Time Division Duplex (TDD) RAT is supported, or may scan 3G TDD RAT when 3G FDD RAT is supported. As such, since the UE randomly selects and scans arbitrary RAT, a delay is inevitable due to scanning and searching failure when the UE scans RAT to which the UE cannot connect.

Due to unnecessary scanning on RAT that is not supported by the UE, a delay is generated in establishing a call (including EMC) so that a user is required to wait to receive a service. Furthermore, such unnecessary scanning consumes the UE's battery.

### SUMMARY

An aspect of the present disclosure has been made to address at least the above-mentioned problems and/or disadvantages and to provide at least the advantages described below. Accordingly, an aspect of the present disclosure is to provide a scheme for reducing a delay time in an attach procedure or a call establishment procedure by avoiding unnecessary scanning on RAT that is not supported by UE.

Another aspect of the present disclosure is to provide a scheme for selecting a cell of RAT to be scanned based on information regarding neighboring cells, before scanning a cell.

Still another aspect of the present disclosure is to provide a scheme for prioritizing at least one cell when selecting a cell to be scanned based on information about neighboring cells.

Still yet another aspect of the present disclosure is to provide an optimal mechanism for selecting a cell to be scanned based on signal intensity for RAT from information about neighboring cells.

### BRIEF DESCRIPTION OF THE DRAWINGS

The above and other aspects, features and advantages of certain embodiments of the present disclosure will be more apparent from the following description taken in conjunction with the accompanying drawings, in which:

FIG. 1 is a flowchart illustrating a method of scanning RAT in a UE, according to an embodiment of the present disclosure;

FIG. 2 is a flowchart illustrating a method of scanning RAT in a UE, according to an embodiment of the present disclosure;

FIG. 3 is a flowchart illustrating a method in which a UE selects another RAT after disabling LTE connection capability, according to an embodiment of the present disclosure;

FIG. 4 is a flowchart illustrating a method in which a UE selects another RAT after disabling LTE connection capability, according to an embodiment of the present disclosure;

FIG. 5 is a flowchart illustrating a method in which a UE selects another RAT after disabling LTE connection capability, according to an embodiment of the present disclosure;

FIG. 6 is a flowchart illustrating a method in which a UE selects another RAT after disabling LTE connection capability, according to an embodiment of the present disclosure;

FIG. 7 is a flowchart illustrating a method in which a UE selects another RAT after disabling LTE connection capability, according to an embodiment of the present disclosure;

FIG. 8 is a flowchart illustrating a method in which a UE selects another RAT after disabling LTE connection capability, according to an embodiment of the present disclosure;

FIG. 9 is a flowchart illustrating a method in which a UE registered in a cell scans RAT in order to move to another cell, according to an embodiment of the present disclosure; and

FIG. 10 is a block diagram illustrating a configuration of a UE, according to an embodiment of the present disclosure.

### DETAILED DESCRIPTION

Reference will now be made in detail to the embodiments of the present disclosure, examples of which are illustrated in the accompanying drawings. In the following description, if it is determined that detailed descriptions for related, well-known functions or configurations make the subject matter of the present disclosure obscure unnecessarily, the detailed descriptions will be omitted. Also, although terms used in the present disclosure were selected as terminology used in the present disclosure while considering the functions of the present disclosure, they may vary according to a user's or operator's intentions.

Before describing the present disclosure, examples of the interpretable meanings of several terms used in this specification will be given. However, the meanings of the terms are not limited to the following interpretations.

As defined herein, a base station communicates with a UE, and may be also referred to as BS, NodeB (NB), eNodeB (eNB), or Access Point (AP).

As defined herein, a UE communicates with a base station, and may be also referred to as UE, Mobile Station (MS), Mobile Equipment (ME), device, or terminal.

As defined herein, a network can be a network entity, such as a base station or Mobility Management Entity (MME). For example, a LTE network may include eNB or MME.

As defined herein, a cell may include a wireless network that operates based on arbitrary RAT. Accordingly, a cell scan can also refer to a network scan.

A UE may check, when scanning to detect a cell (or run to which the UE is to move, information relating to neighboring cells, and select RAT to be scanned based on the information relating to the neighboring cells.

Also, the UE may check, when failure occurs during a Non-Access Stratum (NAS) procedure, such as Circuit Switched FallBack (CSFB) or Extended Service Request (ESR). information relating to the neighboring cells, and select RAT to be scanned based on the information relating to the neighboring cells. The case in which failure occurs during the NAS procedure may include at least one of a case in which delivery failure occurs in the lower layer (that is, an Access Stratum (AS) layer), and a case in which a NAS response message (for example, an attach accept message) indicating “CS fallback not available”, “IMS voice not available”, “SMS only”, “CS fallback not preferred”, “network failure”, “CS domain not available” or “EPS service not available in PLMN” is received from a network.

In accordance with an aspect of the present disclosure there is provided a method for scanning RAT of a UE registered in a first cell in a cellular communication network. The method includes performing a Non-Access Stratum (NAS) procedure for establishing a call, disabling, if the NAS procedure fails, capability of the UE to connect to the first cell, checking information relating to neighboring cells in the network, and selecting at least one RAT included in the information relating to the neighboring cells, and scanning a second cell operating in the at least one RAT based on the information relating to the neighboring cells.

In accordance with an aspect of the present disclosure there is provided a UE for scanning RAT, wherein the UE is registered in a first cell in a cellular communication network. The UE includes a controller configured to perform a NAS procedure for establishing a call, to disable, if the NAS procedure fails, capability of the UE to connect to the first cell, to check information relating to neighboring cells and select at least one RAT included in the information relating to the neighboring cells, and to scan a second cell operating in the at least one RAT based on the information relating to the neighboring cells, and a transceiver to transmit and receive a signal.

In accordance with an aspect of the present disclosure there is provided a System on Chip (SoC). The SoC includes a controller module configured to perform a NAS procedure for establishing a call, to disable, if the NAS procedure fails, capability of connecting to a first cell, to check information relating to neighboring cells, to select at least one RAT included in the information relating to the neighboring cells, and to scan a second cell operating in the at least one RAT based on the information relating to the neighboring cells, and a transceiver module configured to transmit and receive a signal.

In accordance with an aspect of the present disclosure there is provided a method of manufacturing a SoC. The method includes forming, on a substrate of the SoC, a controller module configured to perform a NAS procedure for establishing a call, to disable, if the NAS procedure fails, capability of connecting to a first cell, to check information relating to neighboring cells, to select at least one RAT included in the information relating to the neighboring cells, and to scan a second cell operating in the at least one RAT based on the information relating to the neighboring cells, and forming, on the substrate of the SoC, a transceiver module to transmit and receive a signal.

In accordance with an aspect of the present disclosure there is provided a method for allowing a UE registered in a first cell in a cellular communication network to select RAT after disabling LTE connection capability. The method includes receiving, at a base station, a message from the UE indicating an emergency call and transmitting a message to the UE indicating that the UE disable LTE connection capability in order for the UE to scan for another RAT.

In accordance with an aspect of the present disclosure there is provided a base station for allowing a UE registered in a first cell in a cellular communication network to select RAT after disabling LTE connection capability. The method includes a controller configured to analyze a message received from the UE indicating an emergency call and a transceiver configured to transmit a message to the UE indicating that the UE disable LTE connection capability in order for the UE to scan for another RAT.

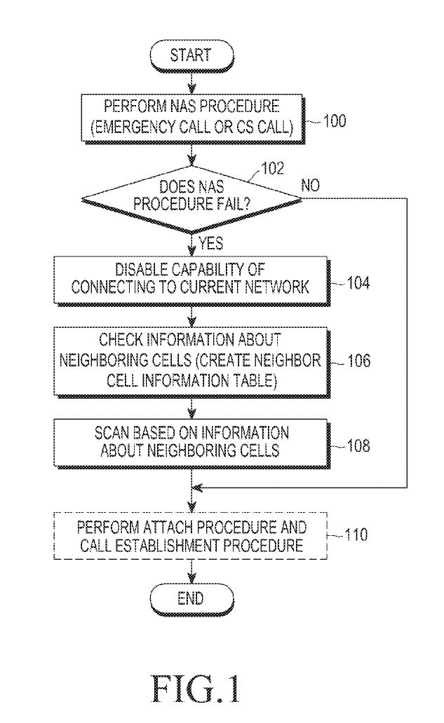

FIG. 1 is a flowchart illustrating a method of scanning RAT in a UE, according to an embodiment of the present disclosure.

Referring to FIG. 1, the UE performs a NAS procedure with a network, at step 100. For example, the UE may perform a NAS procedure in order to initialize an emergency call or a CS-based call (that is, a CS call).

The UE determines whether the NAS procedure fails, at step 102. If the UE determines that the NAS procedure fails, the UE disables capability of connecting to a network (for example, a LTE network) in which the UE is currently registered, at step 104, selects a cell (for example, a second-generation (2G) cell based on GERAN or Code Division Multiple Access (CDMA), or a third-generation (3G) cell based on UTRAN) of another RAT, and tries to connect to the selected cell.

The UE checks information relating to neighboring cells based on a message received from an AS layer, at step 106. At this time, the UE prioritizes at least one cell according to RAT based on at least one of availability and signal intensity from the information relating to the neighboring cells and creates a neighboring cell information table. The step of checking information relating to the neighboring cells may be performed by a NAS module of the UE since the NAS module can manage (or control) information relating to the neighboring cells, which is received as a message from the AS layer. For example, the information relating to the neighboring cells may be transmitted from the network to the UE through a Radio Resource Control (RRC) layer message. The information relating to the neighboring cells may further include information of UTRA Absolute Radio Frequency Number (UARFCN) and EUTRA Absolute Radio Frequency Number (EARFCN), in addition to information related to RAT (for example, availability and signal intensity of RAT).

The UE scans at least one cell based on the information relating to neighboring cells, at step 108. At this time, the UE first scans a cell to which priority is allocated, thereby avoiding a delay due to scan failure. For example, if the information relating to the neighboring cells includes only information relating to 3G Frequency Division Duplex (FDD)-based cells, the UE scans a 3G cell in the FDD mode. In another example, if the information relating to the neighboring cells includes only information relating to 3G Time Division Duplex (TDD)-based cells, the UE scans a 3G cell in the TDD mode. In another example, if the information relating to the neighboring cells includes only information relating to 2G cells, the UE scans a 2G cell. In another example, if the information relating to the neighboring cells includes information relating to 2G and 3G cells, the UE first scans a cell of RAT having the highest signal intensity.

The UE selects RAT using the information of UARFCN or EARFCN. More specifically, the UE uses the UARFCN or EARFCN as an index of a cell to be scanned.

If there is no information relating to the neighboring cells, the UE infers a RAT that is supported by the corresponding country based on Subscriber Identification Module (SIM) type information or Mobility Country Code (MMC) information to select a RAT to be scanned, thereby increasing the success probability of scanning.

If the UE acquires cell information (for example, a cell identifier) as the result of the scanning, the UE performs an attach procedure or a call establishment procedure, at step 110.

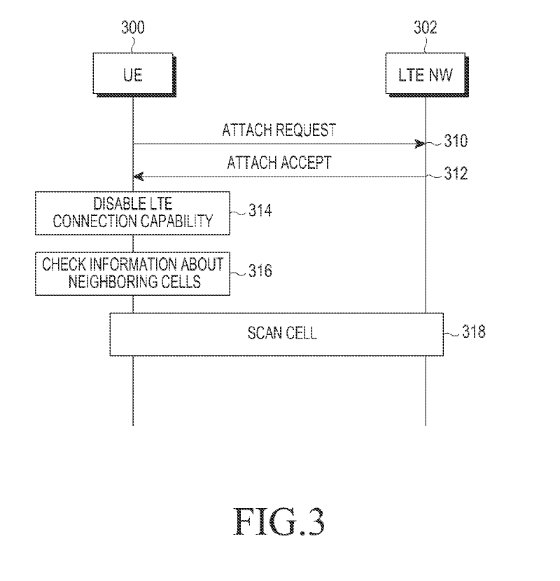

Hereinafter, various embodiments of the method described above with reference to FIG. 1 will be described in more detail with reference to FIGS. 3-8.

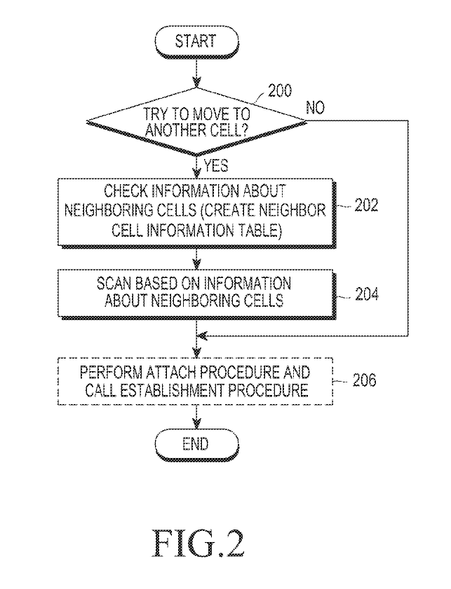

FIG. 2 is a flowchart illustrating a method of scanning RAT in a UE, according to another embodiment of the present disclosure.

If a UE registered in a cell of RAT (for example, any one of 2G (GSM, CDMA), 3G (UTRA), and 4G (EUTRA)) tries to move to a cell of another RAT, at step 200, the UE selects the cell of the other RAT, and tries to connect to the cell. For example. in a scenario in which the UE is operating in 3G, 2G, or CDMA and selects an EUTRA cell to move to a LTE network, the method of FIGS. 1 and 2 can be used.

The UE checks information relating to neighboring cells in the AS layer such that the UE obtains information related to the neighboring cells, at step 202. The UE prioritizes at least one cell according to RAT based on at least one of availability and signal intensity from information obtained relating to the neighboring cells, and creates a neighboring cell information table. The step of checking information relating to the neighboring cells may be performed by the NAS module of the UE, since the NAS module can manage (or control) information relating to the neighboring cells, which is received as a message from the AS layer. For example, the information relating to the neighboring cells may be transmitted from the network to the UE through a RRC layer message. The information relating to the neighboring cells may further include information related to UARFCN and EARFCN, in addition to information related to RAT (for example, availability and signal intensity of RAT).

The UE scans at least one cell based on the information relating to neighboring cells, at step 204. At this time, the UE first scans a cell to which priority is allocated, thereby avoiding a delay due to scan failure. For example, if the information relating to the neighboring cells includes only information relating to LTE-based cells, the UE scans a LTE-based cell. In another example, if the information relating to the neighboring cells includes only information about 3G FDD-based cells, the UE scans a 3G cell in the FDD mode. In another example, if the information relating to the neighboring cells includes only information about 3G TDD-based cells, the UE scans a 3G cell in the TDD mode. In another example, if the information relating to the neighboring cells includes only information about 2G cells, the UE scans a 2G cell. In another example, if the information relating to the neighboring cells includes information about 2G and 3G cells, the UE first scans a cell of RAT having the highest signal intensity.

The UE selects RAT using the information relating to UARFCN or EARFCN. More specifically, the UE uses the UARFCN or EARFCN information as an index of a cell to be scanned.

If there is no information relating to the neighboring cells, the UE infers RAT that is supported by the corresponding country based on SIM type information or MMC information to select RAT to be scanned, thereby increasing the success probability of scanning.

If the UE acquires cell information (for example, a cell identifier) as the result of the scanning, the UE performs an attach procedure or a call establishment procedure, at step 206.

FIG. 3 is a flowchart illustrating a method in which a UE selects another RAT after disabling LTE connection capability, according to an embodiment of the present disclosure.

Referring to FIG. 3, a UE 300 registered in a LTE network (LTE NW) 302 performs an attach procedure to start a service, at step 310. More specifically, the UE 300 transmits an “Attach Request” message to the LTE NW 302. Herein, it is assumed that the UE 300 operates in CS/PS mode 1, and the LTE NW 302 supports no 2G RAT. The LTE NW 302 may be a network entity, such as a base station or MME.

The LTE network 302 transmits an “Attach Accept” message or a “TAU Accept” message to the UE 300, in response to the “Attach Request” message, at step 312.

If the “Attach Accept” message or the “TAU Accept” message includes information indicating “SMS only” or “CSFB not Preferred”, the UE 300 disables LTE connection capability (that is, EUTRA capability), at step 314, in order to scan another RAT (for example, 2G, 3G, CDMA, etc.) to connect to the other RAT.

At this time, the UE 300 checks information relating to neighboring cells, at step 316. The UE 300 determines RAT included in the information relating to the neighboring cells and selects the determined RAT as RAT to be scanned.

The UE 300 scans the selected RAT, at step 318. In this way, the UE 300 can avoid scan failure that is caused by scanning an unsupported RAT, while reducing a delay time taken to scan RAT. If the UE 300 does not use information relating to the neighboring cells, the UE 300 may experience a delay due to scan failure that is caused by scanning an unsupported RAT (for example, 2G). However, since the UE 300 uses information relating to the neighboring cells, the UE 300 restores a service directly without any delay.

The UE 300 scans the selected RAT to acquire a cell identifier and performs an attach procedure and a call establishment procedure with a network corresponding to the cell identifier.

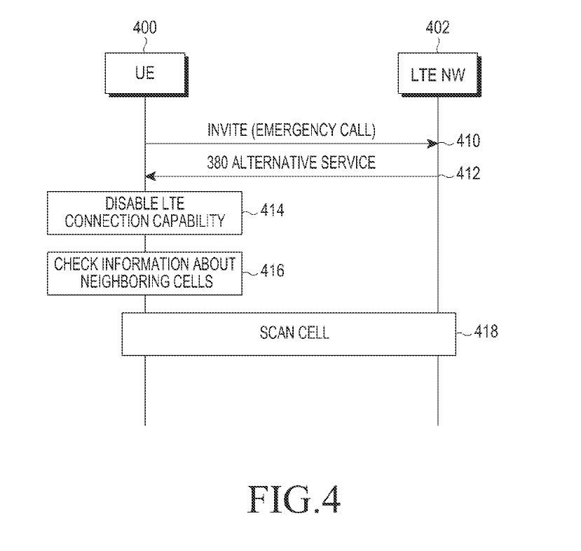

FIG. 4 is a flowchart illustrating a method in which UE selects another RAT after disabling LTE connection capability, according to an embodiment of the present disclosure.

Referring to FIG. 4, a UE 400 registered in an LTE NW 402 performs an initialization procedure to send a call (for example, an emergency call), at step 410. More specifically, the UE 400 transmits an “Invite” message indicating an emergency call to the LTE NW 402. Herein, it is assumed that the UE 400 operates in CS/PS mode 1, and the LTE NW 402 supports no 2G RAT. The CS/PS mode 1 is used for setting a UE defined in the 3GPP TS 24.301, wherein the UE is registered in both an EPS service and a non-EPS service, and set to “voice centric”.

Since the emergency call is limited in the LTE NW 402, the UE 400 receives a “380 Alternative Service” message from the LTE NW 402, in response to the “Invite” message, at step 412.

If the UE 400 receives the “380 Alternative Service” message, the UE 400 disables LTE connection capability (that is, EUTRA capability), at step 414, in order to scan another RAT (for example, 2G, 3G, CDMA, and the like) to connect to the other RAT.

At this time, the UE 400 checks information relating to neighboring cells, at step 416. The UE 400 determines RAT included in the information relating to the neighboring cells and selects the determined RAT as RAT to be scanned.

The UE 400 scans the selected RAT, at step 418. In this way, the UE 300 avoids scan failure that is caused by scanning an unsupported RAT, while reducing a delay time taken to scan RAT.

The UE 400 scans the selected RAT to acquire a cell identifier and performs an attach procedure and a call establishment procedure with a network corresponding to the cell identifier.

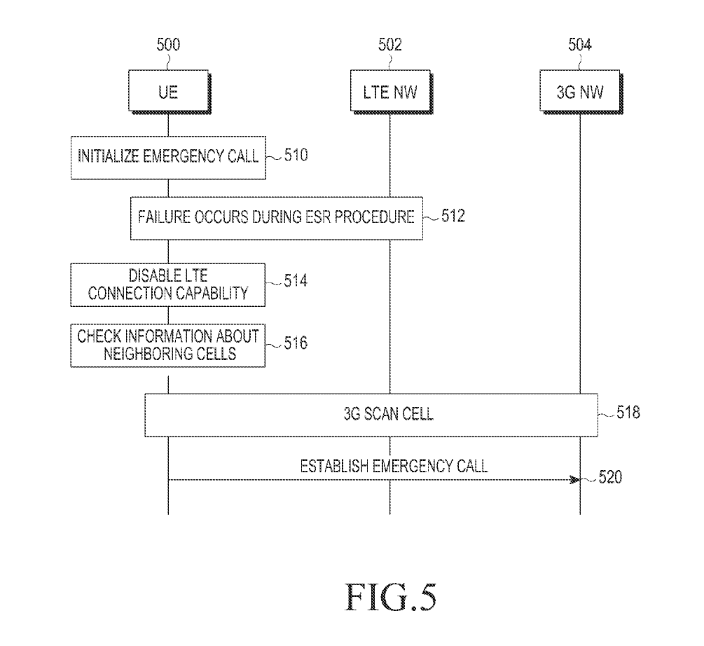

FIG. 5 is a flowchart illustrating a method in which a UE selects another RAT after disabling LTE connection capability, according to an embodiment of the present disclosure.

Referring to FIG. 5, a UE 500 registered in a LTE NW 502 initializes an emergency call, at step 510. Herein, it is assumed that the UE 500 operates in CS/PS mode 1, and no cell among neighboring cells supports 2G RAT.

When initializing the emergency call, the UE 500 performs a procedure (that is, an ESR procedure) of transmitting an ESR message to the LTE NW 502. The ESR procedure is performed using signals of the NAS layer, and may include a CSFB procedure that is originated by the UE 500. However, if delivery failure occurs in the lower layer (for example, a Random Access Channel (RACH)) during the ESR procedure, at step 512, the ESR message may be not transmitted to the LTE network 502.

If the ESR message is not transmitted to the LIE NW 502 or a response message indicating that CSFB is not supported (for example, “CS fallback not available”, “IMS voice not available”, “SMS only”, “CS fallback not preferred”, “network failure”, “CS domain not available”, and “EPS service not available in PLMN”) is received, that is, if the ESR procedure fails, the UE 500 disables EUTRA capability, at step 514 and performs cell scan in order to connect to another RAT.

At this time, the UE 500 checks information about neighboring cells, at step 516. Then, the UE 500 selects (determines) at least one RAT included in the information relating to the neighboring cells, as RAT to be scanned.

For example, if the information relating to the neighboring cells includes only information about 3G cells, the UE 500 scans 3G RAT, at step 518. In this way, the UE 500 avoids scan failure that is caused by scanning an unsupported RAT, while reducing a delay time taken to scan RAT.

The UE 500 scans the selected RAT to acquire a cell identifier and performs an attach procedure and a call establishment procedure with a network (that is, a 3G network) 504 corresponding to the cell identifier, at step 520.

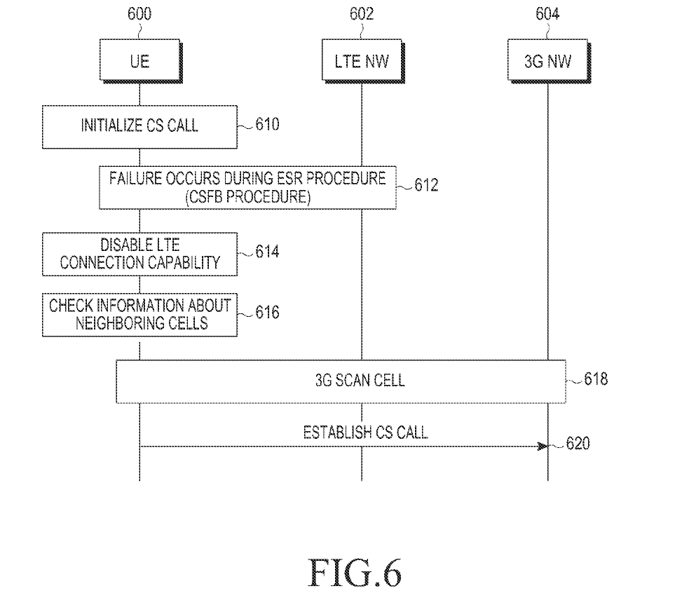

FIG. 6 is a flowchart illustrating a method in which a UE selects another RAT after disabling LTE connection capability, according to an embodiment of the present disclosure.

Referring to FIG. 6, a UE 600 registered in a LTE NW 602 may initialize a CS call, at step 610. Herein, it is assumed that the UE 600 operates in CS/PS mode 1 and no cell among neighboring cells supports 2G RAT.

When initializing the CS call, the UE 600 performs an ESR procedure with the LIE NW 602. The ESR procedure may include a CSFB procedure that is originated by the UE 600. However, if delivery failure occurs in the lower layer (for example, RACH) during the CSFB procedure, at step 612, the ESR message may be not transmitted to the LTE network 602.

If the ESR message is not transmitted to the LTE NW 602 or a response message indicating that CSFB is not supported is received, that is, if the CSFB procedure fails, the UE 600 disables EUTRA capability, at step 614 and performs cell scan in order to connect to another RAT.

At this time, the UE 600 checks information relating to neighboring cells, at step 616. Then, the UE 600 selects (determines) at least one RAT included in the information relating to the neighboring cells, as RAT to be scanned.

For example, if the information relating to the neighboring cells includes only information about 3G cells, the UE 600 selects and scans 3G RAT, at step 618. In this way, the UE 600 avoids scan failure that is caused by scanning an unsupported RAT (for example, 2G), while reducing a delay time taken to scan RAT.

The UE 600 scans the selected RAT to acquire a cell identifier and performs an attach procedure and a call establishment procedure with a network (such as, a 3G network) 604 corresponding to the cell identifier, at step 620.

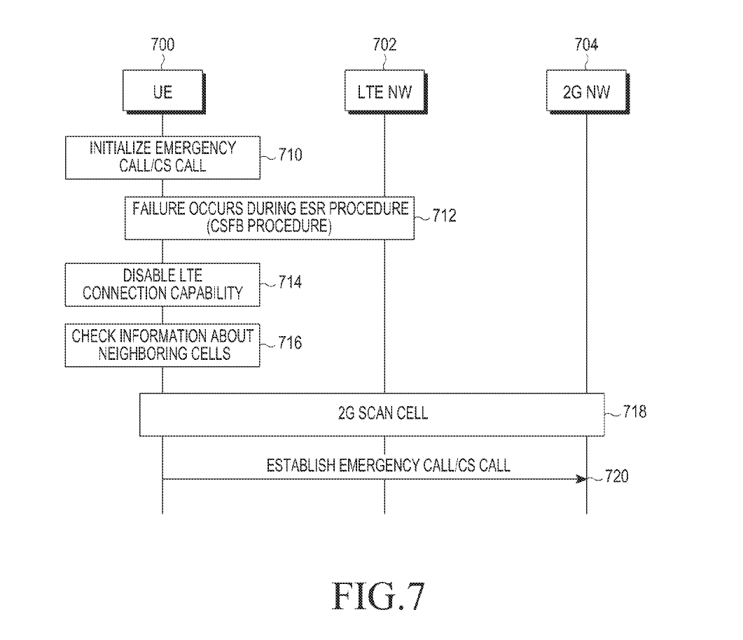

FIG. 7 is a flowchart illustrating a method in which a UE selects another RAT after disabling LTE connection capability, according to an embodiment of the present disclosure.

Referring to FIG. 7, UE 700 registered in a LTE NW 702 initializes a CS call or an emergency call, at step 710. Herein, it is assumed that the UE 700 operates in CS/PS mode 1 and no cell among neighboring cells supports 3G RAT.

When initializing the CS call or the emergency call, the UE 700 performs an ESR procedure with the LTE NW 702. The ESR procedure may include a CSFB procedure that is originated by the UE 700. However, if delivery failure occurs in the lower layer (for example, RACH) during the CSFB procedure, at step 712, the ESR message may be not transmitted to the LTE NW 702.

If the ESR message is not transmitted to the LTE NW 702 or a response message indicating that CSFB is not supported is received, that is, if the CSFB procedure fails, the UE 700 disables EUTRA capability, at step 714, and performs cell scan in order to connect to another RAT.

At this time, the UE 700 checks information relating to neighboring cells, at step 716. Then, the UE 700 selects (or determines) at least one RAT included in the information relating to the neighboring cells, as RAT to be scanned.

For example, if the information relating to the neighboring cells includes only information about 2G cells, the UE 700 scans 2G RAT, at step 718. In this way, the UE 700 avoids scan failure that is caused by scanning an unsupported RAT (for example, 3G), while reducing a delay time taken to scan RAT.

The UE 700 scans the selected RAT to acquire a cell identifier and performs an attach procedure and a call establishment procedure with a network (such as, a 2G network) 704 corresponding to the cell identifier, at step 720.

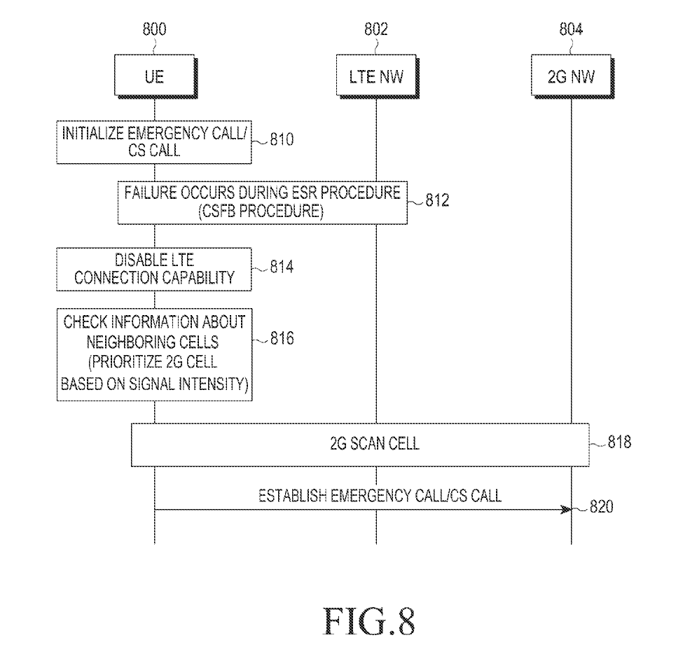

FIG. 8 is a flowchart illustrating a method in which a UE selects another RAT after disabling LTE connection capability, according to an embodiment of the present disclosure.

Referring to FIG. 8, UE 800 registered in a LTE NW 802 initializes a CS call or an emergency call, at step 810. Herein, it is assumed that the UE 800 operates in CS/PS mode 1 and at least one cell among neighboring cells supports 2G (GSM, CDMA) and 3G RAT.

When initializing the CS call or the emergency call, the UE 800 performs an ESR procedure with the LTE NW 802. The ESR procedure may include a CSFB procedure that is originated by the UE 800. However, if delivery failure occurs in the lower layer (for example, RACH) during the CSFB procedure, at step 812, the ESR message may be not transmitted to the LTE NW 802.

If the ESR message is not transmitted to the LTE NW 802 or a response message indicating that CSFB is not supported is received, that is, if the CSFB procedure fails, the UE 800 disables EUTRA capability, at step 814, and performs cell scan in order to connect to another RAT.

At this time, the UE 800 checks information relating to neighboring cells, at step 816. The UE 800 selects (determines) at least one RAT included in the information relating to the neighboring cells, as RAT to be scanned. The UE prioritizes at least one cell based on at least one of availability and signal intensity for at least one RAT of the neighboring cells from the information relating to the neighboring cells.

For example, if the information relating to the neighboring cells includes information about 2G, 3G and CDMA cells, wherein the 2G cell has the highest signal intensity, the UE 800 selects and scan 2G RAT, at step 818. In this way, the UE 800 scans RAT having the highest success probability of connection, while avoiding scan failure that is caused by scanning a cell to which the UE 800 is not to connect to. Accordingly, the UE 800 can reduce a delay time taken to scan RAT.

The UE 800 scans the selected RAT to acquire a cell identifier and performs an attach procedure and a call establishment procedure with a network (such as, a 2G network) 804 corresponding to the cell identifier, at step 820.

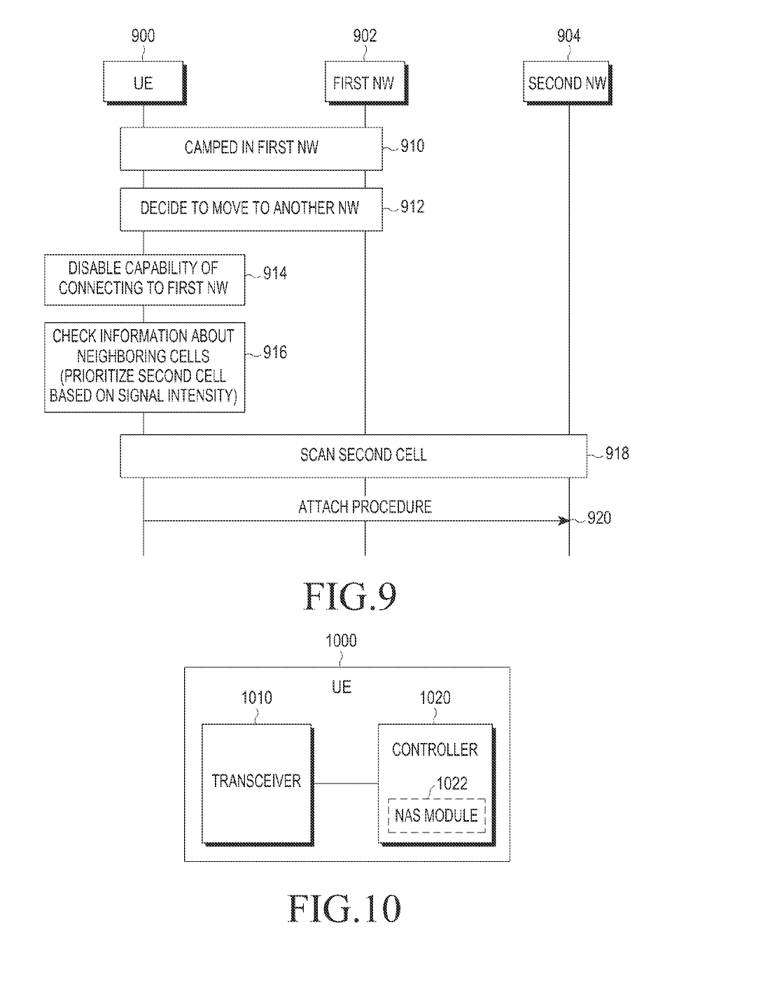

FIG. 9 is a flowchart illustrating a method in which a UE registered in a cell scans RAT in order to move to another cell, according to an embodiment of the present disclosure.

Referring to FIG. 9, UE 900 may be registered (or camped) in a first network (First NW) 902, at step 910.

The UE 900 camped in the First NW 902 may decide to move to another network, at step 912. The UE 900 that decided to move to another network disables capability of connecting to the first network 902, at step 914.

Before scanning a cell to which the UE 900 moves, the UE 900 checks information relating to neighboring cells, at step 916. The UE 900 prioritizes availability and signal intensity for RAT based on the information relating to the neighboring cells and creates a RAT table. Thereafter, the UE 900 selects (determines) RAT to be scanned with reference to the RAT table.

For example, if the information relating to the neighboring cells includes information about 2G, 3G, and CDMA cells, wherein the 2G cell has the highest signal intensity, the UE 900 selects and scans 2G RAT as a second network, at step 918. In this way, the UE 900 scans RAT having the highest success probability of connection, while avoiding scan failure that is caused by scanning a cell to which the UE 900 is not to connect to. Accordingly, the UE 900 reduces a delay time taken to scan RAT.

The UE 900 scans the selected RAT to acquire a cell identifier and performs an attach procedure and a call establishment procedure with a network (such as, a 2G network) 904 corresponding to the cell identifier, in operation 920.

FIG. 10 is a block diagram illustrating a configuration of UE 1000 (or a base station), according to an embodiment of the present disclosure.

Referring to FIG. 10, the UE 1000 includes a transceiver 1010 to transmit/receive various signals or data to/from various network entities and a controller 1020 to control the transceiver 1010. The controller 1020 may control overall operations of the UE 1000. More specifically, the controller 1020 may include a NAS module to check information about neighboring cells.

For easy understanding, the transceiver 1010 is shown to be separated from the controller 1020, however, the transceiver 1010 and the controller 1020 may be implemented as one component such as a single chip, e.g., a System on Chip (SoC). For example, the components illustrated in FIG. 10 can be integrated on one or more substrates of an SoC.

The methods, the network procedures, and the configuration of UE as shown in FIGS. 1-10 are not intended to limit the scope of the present disclosure. That is, all components or operations shown in FIGS. 1-10 should not be interpreted as essential components for embodying the present disclosure, and the present disclosure can be embodied using a part of the components, without departing from the technical features of the present disclosure.

The above-described operations can be realized by including a memory device storing the corresponding program code in network entity, a base station, MME, or an arbitrary component of UE of communication system. That is, the network entity, the base station, the MME, or the controller of the UE can execute the above-described operations by reading and executing the program code stored in the memory device through a processor or a Central Processing Unit (CPU).

The network entity, the base station, the MME, various components of the UE, the module, etc. as mentioned in the present specification can operate using a hardware circuit, for example, a complementary metal oxide semiconductor-based logic circuit, firmware, software, and/or a combination of hardware and firmware and/or software installed in machine-readable medium. For example, various electrical structures and methods may be embodied using transistors, logic gates, and electrical circuits such as an Application Specific Integrated Circuit (ASIC).

Therefore, according to the embodiments of the present disclosure as described, by avoiding unnecessary scanning on RAT that is not supported by UE, it is possible to reduce a delay time during establishment of a CS call.

Also, according to the embodiments of the present disclosure as described, by avoiding unnecessary scanning on RAT that is not supported by UE, it is possible to save the battery life of the UE.

Also, according to the embodiments of the present disclosure as described, by considering priority based on information about neighboring cells, it is possible to optimize a procedure of selecting a cell to be scanned.

While the present disclosure has been shown and described with reference to certain embodiments thereof, it should be understood by those skilled in the art that many variations and modifications of the methods and apparatuses described herein will still fall within the spirit and scope of the present disclosure as defined in the appended claims and their equivalents.

What is claimed is:

1. A method for scanning Radio Access Technology (RAT) of a User Equipment (UE) registered in a first cell in a cellular communication network, comprising:
performing a Non-Access Stratum (NAS) procedure for establishing a call;
disabling, if the NAS procedure fails, capability of the UE to connect to the first cell;
checking information relating to neighboring cells in the network, and selecting at least one RAT included in the information relating to the neighboring cells; and
scanning a second cell operating in the at least one RAT based on the information relating to the neighboring cells.

2. The method of claim 1, wherein the call is one of an emergency call and a Circuit Switched (CS) call.

3. The method of claim 1, wherein the NAS procedure is one of an attach procedure and a CS FallBack (CSFB) procedure.

4. The method of claim I, wherein the selected at least one RAT is one of a Long Term Evolution (LTE), a Global System for Mobile Communications (GSM), a Universal Mobile Telecommunications System (UMTS), and a Code Division Multiple Access (CDMA).

5. The method of claim 1, wherein the NAS procedure fails due to delivery failure of a Random Access Channel (RACH).

6. The method of claim 1, wherein the NAS procedure fails due to receiving, at the UE, a response message indicating at least one of “CS fallback not available”, “Instant Messaging Service (IMS) voice not available”, “Short Message Service (SMS) only”, “CS fallback not preferred”, “network failure”, “CS domain not available” and “Evolved Packet System (EPS) service not available in Public Land Mobile Network (PLMN)”.

7. The method of claim 1, wherein selecting the at least one RAT comprises:
prioritizing the at least one RAT based on availability and signal intensity included in the information relating to the neighboring cells; and
selecting the prioritized RAT.

8. The method of claim 7, wherein prioritizing the at least one RAT further comprises creating a neighboring cell information table including the prioritized RAT.

9. The method of claim 1, wherein the at least one RAT is selected using at least one of Universal Mobile Telecommunication Systems (UMTS) Terrestrial Radio Access (UTRA) Absolute Radio Frequency Number (UARFCN), EUTRA Absolute Radio Frequency Number (EARFCN), Subscriber Identification Module (SIM) type information, and Mobility Country Code (MCC) information.

10. The method of claim 1, further comprising performing at least one of an attach procedure and a call establishment procedure with the scanned cell.

11. A User Equipment (UE) for scanning Radio Access Technology (RAT), wherein the UE is registered in a first cell in a cellular communication network, comprising:
a controller configured to perform a Non-Access Stratum (NAS) procedure for establishing a call, to disable, if the NAS procedure fails, capability of the UE to connect to the first cell, to check information relating to neighboring cells and select at least one RAT included in the information relating to the neighboring cells, and to scan a second cell operating in the at least one RAT based on the information relating to the neighboring cells, and
a transceiver to transmit and receive a signal.

12. The UE of claim 11, wherein the call is one of an emergency call and a Circuit Switched (CS) call.

13. The UE of claim 11, wherein the NAS procedure is one of an attach procedure and a CS FallBack (CSFB) procedure.

14. The UE of claim 11, wherein the selected at least one RAT is one of a Long Term Evolution (LTE), a Global System for Mobile Communications (GSM), a Universal Mobile Telecommunications System (UMTS), and a Code Division Multiple Access (CDMA).

15. The UE of claim 11, wherein the NAS procedure fails due to delivery failure of a Random Access Channel (RACH).

16. A System on Chip (SoC), comprising:
a controller module configured to perform a Non-Access Stratum (NAS) procedure for establishing a call, to disable, if the NAS procedure fails, capability of connecting to a first cell, to check information relating to neighboring cells, to select at least one RAT included in the information relating to the neighboring cells, and to scan a second cell operating in the at least one RAT based on the information relating to the neighboring cells, and
a transceiver module configured to transmit and receive a signal.

17. The SoC of claim 16, wherein the call is one of an emergency call and a Circuit Switched (CS) call.

18. The SoC of claim 16, wherein the NAS procedure is one of an attach procedure and a CS FallBack (CSFB) procedure.

19. The SoC of claim 16, wherein the selected at least one RAT is one of a Long Term Evolution (LTE), a Global System for Mobile Communications (GSM), a Universal Mobile Telecommunications System (UMTS), and a Code Division Multiple Access (CDMA).

20. The SoC of claim 16, wherein the NAS procedure fails due to delivery failure of a Random Access Channel (RACH).
